(19) United States
(12) Patent Application Publication
(10) Pub. No.: US 2013/0273225 A1
(43) Pub. Date: Oct. 17, 2013

(54) NATURAL MEAL REPLACEMENT BAR FOR DOGS

(71) Applicant: Reynolds Ellsworth Moulton, Brooklyn, NY (US)

(72) Inventor: Reynolds Ellsworth Moulton, Brooklyn, NY (US)

(21) Appl. No.: 13/445,892

(22) Filed: Apr. 12, 2012

(51) Int. Cl. A23K 1/18; A23P 1/12; A23K 1/16; A23K 1/20; A23L 3/40; A23L 3/34; A23P 1/08

(52) U.S. Cl. 426/545; 426/657; 426/392

(57) ABSTRACT

The embodiments herein provide an all natural meal replacement bar for dogs comprising a protein, fat, fiber and ash content. The protein, fat, and fiber are present respectively at an amount of 38% by weight, 8% by weight, 2% by weight. The protein is made from an extract selected from a group consisting of an extract of an animal protein and an extract of a plant protein. The meal replacement bar containing a moisture content of 18% by weight for dogs is a grain-free proteinaceous bar. The natural meal replacement bar replaces a daily meal for the dogs.

### BACKGROUND

1. Technical Field

The embodiments herein generally relate to a natural food replacement product for dogs and particularly to a natural food product in a shape of a bar. The embodiments herein more particularly relates to a meal replacement bar for dogs.

2. Description of the Related Art

Pet foods are primarily composed of plant or animal ingredients which are consumed by a pet, or “companion” animals. The pet food is specific to the type of animal such as dog or cat.

Meal replacement products (“MRP”s) are typically either in a pre-packaged powdered drink mix or an edible bar format and are designed to replace prepared meals. The MRPs includes a high protein and low fat content. The MRPs also typically have a moderate amount of carbohydrates and further contain a wide array of vitamins and the minerals.

The majority of MRPs use whey protein, casein (often listed as calcium caseinate or micellar casein), soy protein, and egg albumin as primary protein sources. The carbohydrates are derived from maltodextrin, oat fiber, brown rice, and wheat flour. The MRPs also contain flax oil powder as a source of the essential fatty acids.

MRPs also contain other ingredients such as creatine monohydrate, glutamine peptides, L-glutamine, calcium alpha-ketoglutarate, additional amino acids, lactoferrin, conjugated linoleic acid, and medium chain triglycerides.

One of the prior arts discloses a food product for pets. The food product disclosed in the exiting prior art comprises high sugar content for providing instant energy to the dogs and other canines. Since continuous consumption of these food products can lead to potential health hazards such as obesity from excess sugar and carbohydrates in the pets, the existing food products should not be used as actual meal replacement. Further, the extrusion process used in the existing prior art method is inefficient in the production of a bar shaped food products.

Another prior art discloses a shelf-stable meat analogue comprised of glycerol and glucose. The product comprises a proteinaceous material selected from defatted soy flour, soy meal, soy concentrate, cereal gluten and egg white powder. The process for a manufacture of meat analogue disclosed in the prior art comprises using insufficient water content with inadequate shelf life of the food bar.

Yet another prior art discloses a method for production of the pet food bars. The method comprises an extrusion and shredding process in order to produce the pet food bar. The extrusion and shredding process used in the prior art method results in the production of the food bar with a thickness of ¼ inches. The food bar produced by the implementation of the existing prior art method fails to hold the rectangular shape of the food bar for a long period.

Thus none of the prior arts provide a meal replacement bar with the essential ingredients required by the pet animals based on their optimal health needs, ingestion and digestion. Hence there is a need for a natural ingredient meal replacement bar with the essential ingredients required by the pet animals. Also, there is a need for a method for producing a meal replacement bar by an extrusion process for retaining a shape of the meal bar.

In the view of the foregoing, there is a need for a method for producing a meal replacement bar which retains its shape for a long period. Also there is a need for a method for producing a meal replacement bar having a long shelf life for storage and portability. Further, there is a need for a meal replacement bar that provides all the essential ingredients in adequate quantity for the pet animals.

### OBJECTS OF THE EMBODIMENTS

The primary objective of the embodiments herein is to provide a meal replacement bar for the pet animals.

Another objective of the embodiments herein is to provide a meal replacement bar with a high shelf life.

Yet another objective of the embodiments herein is to provide a meal replacement bar with all the essential ingredients required by the pet animals.

Yet another objective of the embodiments herein is to provide a method for producing a meal replacement bar for pet animals.

Yet another objective of the embodiments herein is to provide an extrusion process for a meal replacement bar which retains the shape of the meal bar.

Yet another objective of the embodiments herein is to provide a layering and rolling process for manufacturing a meal replacement bar.

These and other objects and advantages of the embodiments herein will become readily apparent from the following detailed description taken in conjunction with the accompanying drawings.

### SUMMARY

The various embodiments herein provide a meal replacement bar for dogs. The meal replacement bar comprised of protein, fat, fiber, and ash content content. The protein is present at an amount of 38% by weight and the protein is made from an extract which is selected from a group consisting of an extract of an animal protein and an extract of a plant protein. The fat is present at a quantity of 8% by weight. The fiber is present at an amount of 2% by weight. The bar has a moisture content of 18% by weight and an ash content of 10% by weight. The meal replacement bar for dogs is a grain-free proteinaceous bar. The meal replacement bar replaces a daily meal for the dogs.

According to an embodiment herein, the meal replacement bar is synthesized from a plurality of raw materials. The plurality of the raw material includes ground carrot, chicken, beef, tapioca, ground sweet potato, potato starch, cheddar cheese, molasses, vegetable glycerin, beet syrup, dried cultured whey and cinnamon.

According to an embodiment herein, the plurality of raw materials are naturally available materials. The plurality of raw materials includes a natural-vitamin and mineral premix. The natural vitamins in the plurality of raw materials are cinnamon and mixed tocopherols (which are derived from vitamin E). The cinnamon and the mixed tocopherals in the plurality of ingredients act as natural preservatives and anti-oxidants while adding flavour also. Whey in the plurality of ingredients acts as a natural antifungal agent.

According to an embodiment herein, the meal replacement bar is synthesized using a cold extrusion process.

According to an embodiment herein, the cold extrusion process comprising the steps of pre-processing a plurality of raw materials, conditioning the plurality of pre-processed raw materials, extruding the plurality of conditioned raw materials to form a bar, subjecting the bar formed to a cold press, layering the cold pressed bar, drying the layered bar and packaging the dried bar.

According to an embodiment herein, the step of pre-processing a plurality of raw ingredients includes receiving the plurality of raw ingredients from a plurality of sources and storing the received plurality of raw ingredients. The received plurality of raw ingredients is stored in three different storages. The three different storages include a cold storage, storage at a room temperature and a bulk storage. The cold storage is used for storing an ingredient containing a raw meat. The storage at a room temperature is used for storing an ingredient having a storage life of 48 hours. The bulk storage is kept for storing an ingredient having a storage life of 1-2 weeks. The step of pre-processing the plurality of raw ingredients further includes weighing the plurality of stored raw ingredients, mixing the plurality of weighed raw ingredients, grinding and milling the plurality of mixed raw ingredients to form a plurality of grinded and milled raw ingredients. Finally, the plurality of grinded and milled raw ingredients is conditioned.

According to an embodiment herein, the step of extruding the plurality of conditioned raw ingredients to form the bar includes mixing an appropriate amount of water with the plurality of conditioned raw ingredients to form a mixture and moulding the mixture formed to obtain a meal replacement bar. The moulding is done by an application of a die. Further, the meal replacement bar obtained is dried to get a meal replacement bar with a preset humidity content and the preset humidity content is 90%. Further, the dried meal replacement bar is cooled by passing an air at an ambient temperature. The ambient temperature is 15° C.-20° C. Finally, the cooled meal replacement bar is enrobed.

According to an embodiment herein, the meal replacement bar is usable for a period of 24 months since a manufacturing time.

According to an embodiment herein, the meal replacement bar is rectangular in shape.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 shows a table illustrating a composition of materials in a meal replacement bar for dogs, according to an embodiment herein.

FIG. 2 shows a flowchart illustrating a method for preparing a meal replacement bar for dogs, according to an embodiment herein.

FIG. 3 shows a flowchart illustrating a method for pre-processing and conditioning the ingredients for preparing a meal replacement bar for dogs, according to an embodiment herein.

FIG. 4 shows a flowchart illustrating a method for extruding the conditioned ingredients for preparing a meal replacement bar for dogs, according to an embodiment herein.

FIG. 5 shows a flowchart illustrating a method for producing a meal replacement bar from the extruded bar, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a meal replacement bar for dogs. The meal replacement bar comprises a protein, fat, and fiber content. The protein is present at an amount of 38% by weight and the protein is made from an extract which is selected from a group consisting of an extract of an animal protein and an extract of a plant protein. The fat is present at a quantity of 8% by weight. The fiber is present at an amount of 2% by weight. The ash is present at an amount of 10% by weight. The bar has a moisture content of 18% by weight. The meal replacement bar for dogs is a grain-free proteinaceous bar. The meal replacement bar replaces a daily meal for the dogs.

According to an embodiment herein, the meal replacement bar is synthesized from a plurality of raw materials. The plurality of the raw material includes ground carrot, chicken, beef, tapioca, ground sweet potato, potato starch, cheddar cheese, molasses, vegetable glycerin, beet syrup, dried cultured whey and cinnamon.

According to an embodiment herein, the meal replacement bar is synthesized using a cold extrusion process.

According to an embodiment herein, the cold extrusion process comprising the steps of pre-processing a plurality of raw materials, conditioning the plurality of pre-processed raw materials, extruding the plurality of conditioned raw materials to form a bar, subjecting the bar formed to a cold press, layering the cold pressed bar, drying the layered bar and packaging the dried bar.

According to an embodiment herein, the step of pre-processing a plurality of raw ingredients includes receiving the plurality of raw ingredients from a plurality of sources and storing the received plurality of raw ingredients. The received plurality of raw ingredients is stored in three different storages. The three different storages include a cold storage, storage at a room temperature and bulk storage. The cold storage is used for storing an ingredient containing a raw meat. The storage at a room temperature is used for storing an ingredient having a storage life of 48 hours. The bulk storage is kept for storing an ingredient having a storage life of 1-2 weeks. The step of pre-processing the plurality of raw ingredients further includes weighing the plurality of stored raw ingredients, mixing the plurality of weighed raw ingredients, grinding and milling the plurality of mixed raw ingredients to form a plurality of grinded and milled raw ingredients. Finally, the plurality of grinded and milled raw ingredients is conditioned.

According to an embodiment herein, the step of extruding the plurality of conditioned raw ingredients to form the bar includes mixing an appropriate amount of water with the plurality of conditioned raw ingredients to form a mixture and moulding the mixture formed to obtain a meal replacement bar. The moulding is done by an application of a die. Further, the meal replacement bar obtained is dried to get a meal replacement bar with preset humidity content and the preset humidity content is 90%. Further, the dried meal replacement bar is cooled by passing an air at an ambient temperature. The ambient temperature is 15° C.-20° C. Finally, the cooled meal replacement bar is enrobed.

According to an embodiment herein, the meal replacement bar is safe for eating for a period of 24 months after manufacturing.

According to an embodiment herein, the meal replacement bar is rectangular in shape, optimized for packing, storage, and transporting.

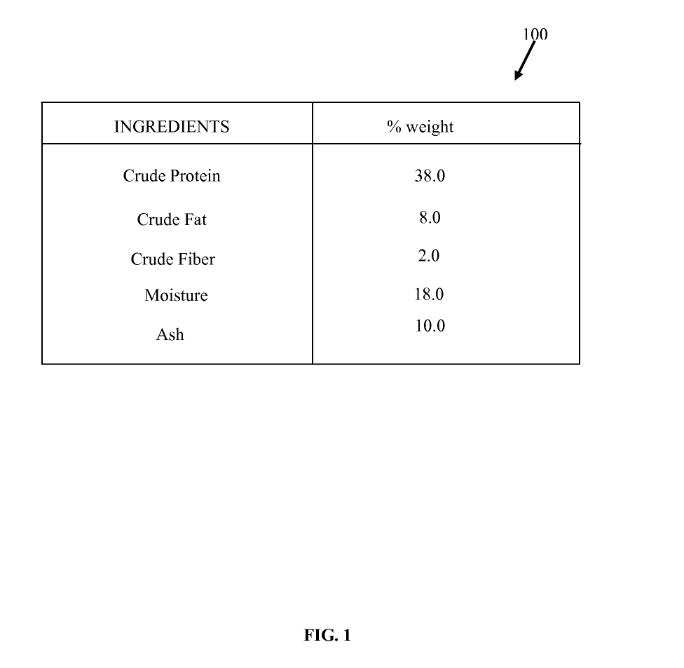

FIG. 1 shows a table illustrating a composition for a meal replacement bar for dogs, according to an embodiment herein. The composition of the meal replacement bar for dogs comprises a protein, fat, fiber and ash. The protein is present at an amount of 38% by weight. The protein is made from an extract. The extract is selected from a group consisting of an extract of an animal protein and an extract of a plant protein. The fat is present in the composition at an amount of 8% by weight while the fiber is present at a ratio of 2% by weight. The ash content in the composition is 10% by weight. The meal replacement bar has a moisture content of 18%. The meal replacement bar for dogs is a grain-free proteinacaseous bar. The meal replacement bar replaces a daily meal for the dogs.

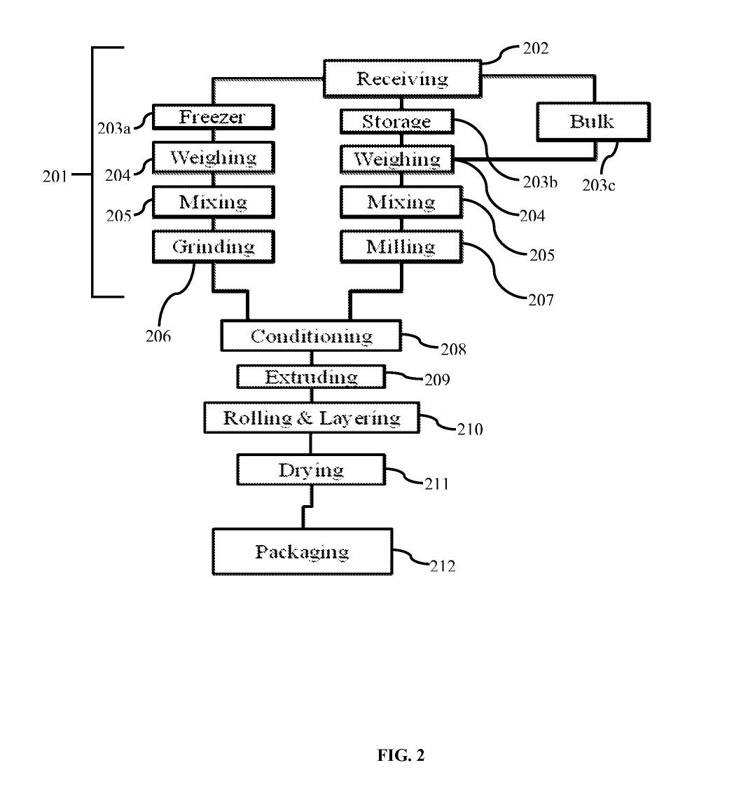

FIG. 2 shows a flowchart illustrating a method for preparing a meal replacement bar for dogs, according to an embodiment herein. With respect to FIG. 2, the method for preparation of meal replacement bar comprises the steps of pre-processing of the ingredients (201). In the pre-processing stage, the raw ingredients are received (202). The plurality of raw ingredients is stored in three different storages including a cold storage, storage at a room temperature and bulk storage. The received ingredients are stored in a cold storage such as a freezer (203a). The cold storage is used for storing an ingredient containing a raw meat. The storage at a room temperature is used for storing an ingredient having a storage life of 48 hours (203b). The bulk storage is used for storing an ingredient having a storage life of 1-2 weeks (203c). The stored ingredients are weighed (204). The weighed ingredients are mixed (205). The mixed ingredients are grinded (206). The ingredients stored at storage at a room temperature and at a bulk storage are milled after the weighing and mixing processes (207).

The pre-processed ingredients are conditioned (208). Then the conditioned ingredients are extruded (209). The extruded ingredients are rolled and layered into a meal replacement bar (210). The layered meal replacement bar is dried (211) and the dried meal replacement bar is packaged (212).

The raw materials are stored, weighed, grinded and milled in appropriate amounts. The raw materials are fresh unprocessed ingredients which are in their natural form. The raw materials are received form a plurality of plant and animal sources. The received raw materials are stored in three different storages such as a cold storage, storage at a room temperature and bulk storage to ensure the freshness of the raw materials. The stored raw materials are weighed to mix the ingredients in the preset ratios. The weighed ingredients are mixed in the pre-determined weight percentages. The extrusion process involves performing a combination of several operations. The several operations include mixing, kneading, shearing, cooling and shaping forming operations. The extrusion process involves compressing the conditioned raw materials such as starches, proteins, salt sugar and other minor ingredients to form a semi solid mass under a controlled ambience. Further the compressed product is forced through a restricted opening such as a shaped hole or slots at a predetermined rate.

The rolling and layering process provides an adequate thickness to the meal replacement bar. The thickness of the meal replacement bar is sufficient to hold the shape of the meal replacement bar for a long period.

The drying of the layered meal replacement bar enhances the stiffness of the meal replacement bars which provides a long shelf life to the meal replacement bars. The dry meal replacement bar is then packaged.

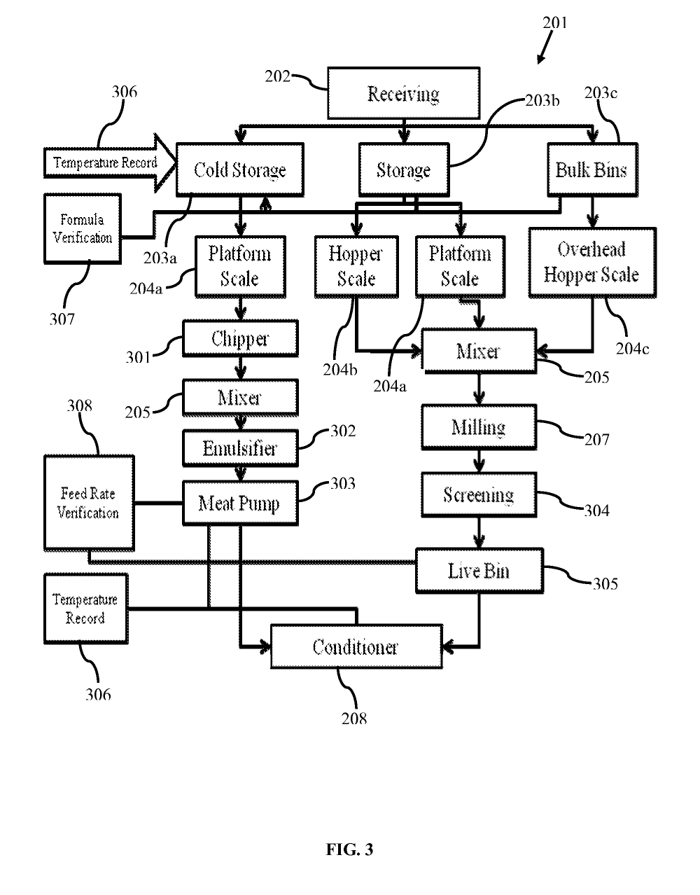

FIG. 3 shows a flowchart illustrating a method for pre-processing and conditioning the ingredients for preparing a meal replacement bar for dogs, according to an embodiment herein. The pre-processing of the ingredients for the meal replacement bars comprises receiving the raw ingredients from a plurality of sources (202). The received ingredients are stored in a storage facility such as a cold storage, a normal storage kept at room temperature and bulk bins (203a-203c). The stored ingredients are weighed using a weighing machine such as a platform scale, hopper scale and overhead hopper scale (204a-204c). The weighed ingredients are mixed to obtain a mixture (205). The mixed ingredients are grinded and milled (207). The grinded and milled ingredients are conditioned (208).

The storage facility includes a cold storage, general storage and bulk bins (203a-203c). The cold storage is used for storing the received raw ingredients such as raw meat ingredients (203a). The general storage is used for storing the raw ingredients with a storage life of 48 hours (203b). The bulk bins are used for storing the raw ingredients with a shelf life of 1-2 weeks (203c).

The stored raw material is weighed using a plurality of weighing means such as a Platform scale, a Hopper scale and an Overhead Hopper scale (204a-204c). The stored raw materials are weighed to provide an appropriate amount of the raw material.

The amount of the weighed ingredients is compared with a pre-fed weight data. The verification of the appropriate weight of the stored ingredients is done through a Formula verification system (307).

The raw materials containing the meat derived ingredients are stored in a cold storage (203a) and weighed using a platform scale (204a). The weighed meat derived ingredients are chipped (301) and the chipped ingredients are mixed through a mixer (205). The weighed ingredients are mixed at the pre-determined weight percentages.

The mixed ingredients are properly emulsified (302). The emulsified ingredients are conditioned (208). The emulsified ingredients are fed to a conditioning system using a meat pump (303). The amount of the emulsified ingredients is checked with a feed rate verification system (308). The temperature of the conditioner is recorded with a temperature recording system to maintain the conditioner at pre set temperature level (306).

The raw materials stored in a general are weighed using a hopper scale (204b) or a platform scale (204c). The raw materials stored in the bulk bins are weighed using an overhead hopper scale (204a). The raw materials stored in the general storage and in the bulk bins are mixed using a mixer after weighing with a platform scale or hopper scale or over head hopper scale (205). The mixed raw materials are further subjected to grinding and milling operations (207). The milled ingredients are screened (304) and stored in a live bin (305). The stored ingredients in the live bin are fed to a conditioner (305). The rate at which the ingredients fed to the conditioner is checked and verified with a feed rate verification system (308).

The screening of a milled product is done to eliminate the ingredients with improper shape. The screening process also eliminates the excess moisture content in the milled ingredients. Furthermore the process includes feeding a powdered material from the milled and screened ingredients for further processing. The powdered material mostly contains dried cultured whey.

The milled and screened ingredients are fed into the conditioner (208). The conditioned ingredients are further subjected to the extrusion process.

The adequate temperature is maintained during the pre-processing of the ingredients by continuously monitoring the temperature. A subsequent record is maintained for the monitored temperature through a Temperature Record system (306).

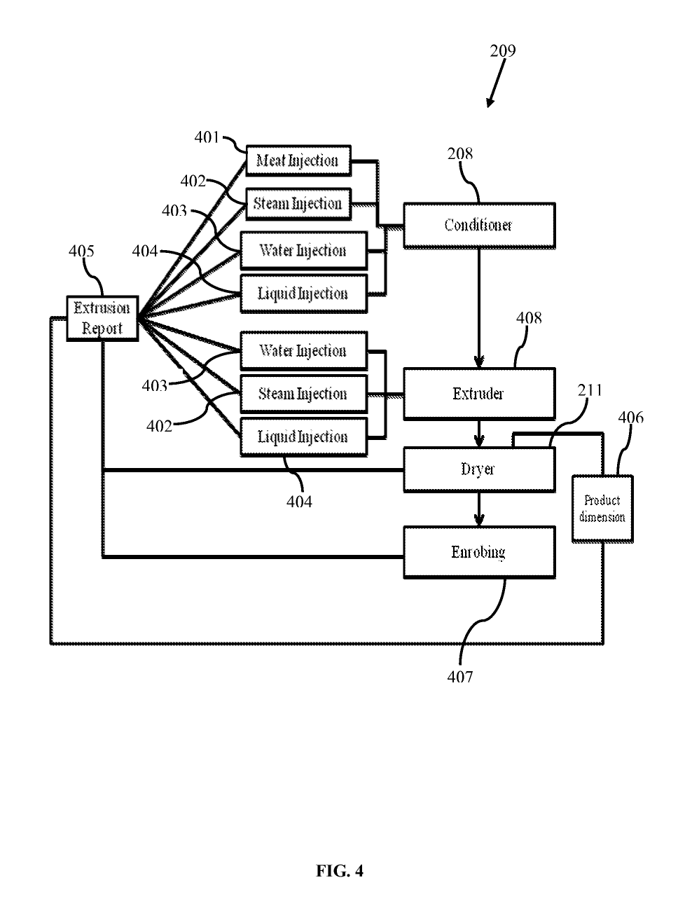

FIG. 4 shows a flowchart illustrating a method for extruding of the conditioned ingredients for preparing a meal replacement bar for dogs, according to an embodiment herein. With respect to FIG. 4, the extruding of the meal replacement bar for dogs is performed after conditioning the pre-processed ingredients. The conditioned raw materials are shaped into a meal replacement bar by the application of a die in an extruder mill (408). The extruded meal replacement bar is then dried using a drier (211). The dried meal replacement bar is treated to have a humidity content of about 90% by chilling the dry meal replacement bar by passing the air at an ambient temperature of about 15-20 degree Celsius. Then the chilled meal replacement bar is enrobed (407).

During the conditioning of the pre-processed ingredients for the meal replacements bar for dogs, the grinded meat ingredients are injected (401). Then steam is injected for sterilizing the contact surfaces of a product (402). Water is injected in appropriate volume (403) and a liquid is injected for pasteurization (404).

The extrusion of the conditioned ingredients in the extruder also includes a water injection, a steam injection and liquid injection operations (402-404). The injection of water, steam and liquid provides adequate energy transfer during the extrusion process.

The drying of the layered meal replacement bar enhances stiffness of the meal replacement bars to provide a long shelf life to the meal replacement bars.

The enrobing of the dry meal replacement bar is done to provide a coating over the meal replacement bar. The coating over the meal replacement bar is a thin layer of flavour-rich hard cellulose and protein based shell which protects the bar from exposure to the air.

The dimension of the meal replacement bar is maintained according to the pre-fed data which is verified through a Product dimension system (406).

The record of temperature and pressure maintained during the extrusion process, dimension of the extruded bar, rate and amount of injection of water, steam, liquid and meat is maintained in an Extrusion Report (405).

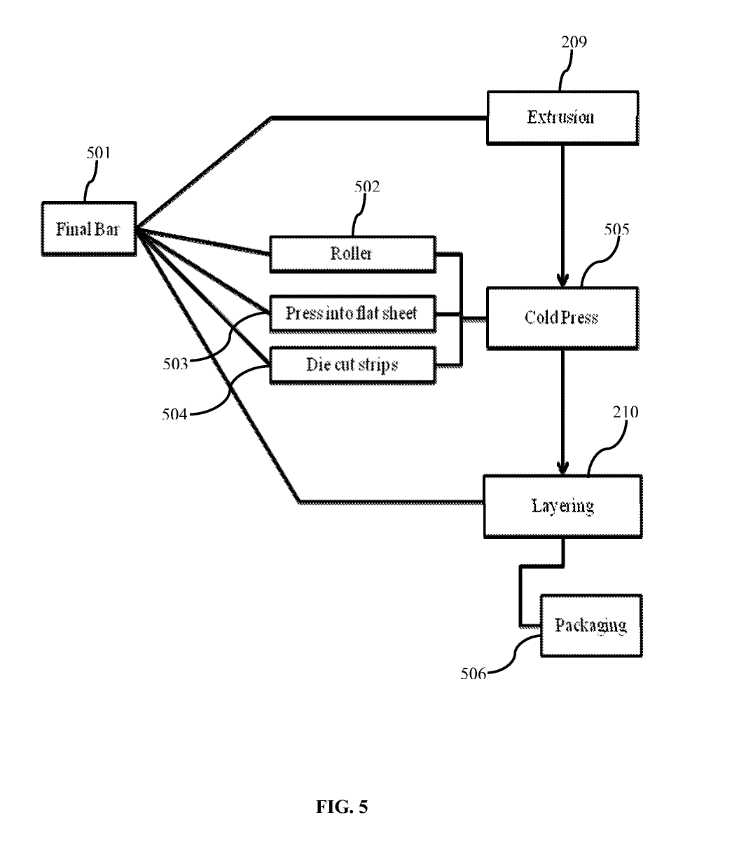

FIG. 5 is a flowchart illustrating a method for preparing a final meal replacement bar from the extruded bar, according to an embodiment herein. With respect to FIG. 5, the final bar is synthesized and packaged meal replacement bar (501). The conditioned ingredients are extruded to a bar shape (209). The extruded bar is applied to a cold press (505). The cold pressed bar is layered (210). The layered bar is then packaged (506).

The extrusion of the conditioned ingredients involves compressing the conditioned raw materials such as starches, proteins, salt sugar and other minor ingredients to form a semi solid mass under a controlled ambience.

The application of the cold-press process comprises subjecting the extruded meal replacement bars to the roller machines (502). Then the rolled meal replacement bar is pressed with the die plates (503). Then the pressed meal replacement bar is cut into predetermined sizes (504).

The embodiments herein are supported with following examples. The examples set forth are not meant to limit the scope in any manner.

### Example 1

### Meal Replacement Bar for Dogs

The meal replacement for dogs is synthesized from a group of plant derived ingredients which further comprises 34% of ground carrot, 22% of tapioca, 18% of ground sweet potato, 14.992% of potato starch, 3% of cheddar cheese, 3% of molasses, 2.7% of vegetable glycerin, 1.7% of beet syrup, 0.6% of dried cultured whey and 0.008% of cinnamon.

### Example 2

### Meal Replacement Bar for Dogs

The meal replacement bar for dogs is synthesized from a combination of a group of animal and a group of plant derived ingredients which further comprises 52% of chicken, 22% of tapioca, 14.992% of potato starch, 3% of cheddar cheese, 3% of molasses, 2.7% of vegetable glycerin, 1.7% of beet syrup, 0.6% of dried cultured whey and 0.008% of cinnamon.

The meal replacement bar for dogs is synthesized from a combination of a group of animal and a group of plant derived ingredients which further comprises 52% of chicken, 22% of tapioca, 14.992% of potato starch, 3% of cheddar cheese, 3% of molasses, 2.7% of vegetable glycerin, 1.7% of beet syrup, 0.6% of dried cultured whey and 0.008% of cinnamon.

### Example 3

### Meal Replacement Bar for Dogs

The layering provides a required thickness to the meal replacement bar. The layering process includes application of a layer in the form of a strip over another strip and pressing the subsequent layers to provide proper adhering between the layers.

The meal replacement bar of the embodiments herein provides a dietary food product to the dogs which are according to the BARF nutrition chart for the dogs and other canines. The meal replacement bar of the embodiments herein discloses a textured and savored bar which attracts the dogs.

The meal replacement bar of the embodiments herein comprises sufficient calorific value so that the dogs rely on the meal replacement bars for a long time. Thus the meal replacement bars prevents the carrying of the bulky food products over long distances. The meal replacement bars of the present invention have a long shelf life.

Although the embodiments have been described in some detail by way of illustration and example for the purposes of clarity of understanding, it is clearly not limited thereby and the embodiments herein encompass any changes and modifications that may be practiced within the scope of the appended claims by ones skilled in the art.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. A natural meal replacement bar for dogs comprising:
a protein, wherein the protein is present at an amount of 38% by weight, and wherein the protein is made from an extract, and wherein the extract is selected from a group consisting of an extract of an animal protein and an extract of a plant protein;
a fat, and wherein the fat is present at an amount of 8% by weight;
a fiber, and wherein the fiber is present at an amount of 2% by weight;
an ash, and wherein the ash is present at an amount of 10% by weight;
a moisture content, and wherein the moisture content is 18% by weight; and wherein the meal replacement bar is a grain-free proteinaceous bar, and wherein the meal replacement bar replaces a daily meal for the dogs.

2. The meal replacement bar according to claim 1, wherein the meal replacement bar is synthesized from a plurality of raw materials, and wherein the plurality of raw materials includes ground carrot, chicken, beef, tapioca, ground sweet potato, potato starch, cheddar cheese, molasses, vegetable glycerin, beet syrup, dried cultured whey and cinnamon.

3. The meal replacement bar according to claim 1, wherein the plurality of raw materials are naturally available materials.

4. The meal replacement bar according to claim 1, wherein the natural preservatives and anti-oxidants in the plurality of raw materials include cinnamon and mixed tocopherols (vitamin E).

5. The meal replacement bar according to claim 1, wherein whey acts as a natural antifungal agent.

6. The meal replacement bar according to claim 1, wherein the meal replacement bars is synthesized using a cold extrusion process.

7. The meal replacement bar according to claim 1, wherein the meal replacement bar is usable for 24 months since a manufacturing time.

8. The meal replacement bar according to claim 1, wherein the meal replacement bar is rectangular in shape.

9. A method of synthesizing a meal replacement bar for dogs comprising the steps of:
pre-processing a plurality of raw ingredients;
conditioning a plurality of pre-processed raw ingredients;
extruding a plurality of conditioned raw ingredients to form a bar;
subjecting the bar formed to a cold press;
layering the bar formed;
drying a layered bar; and
packaging a dried bar.

10. The method according to claim 11, wherein the step of pre-processing a plurality of raw ingredients further comprising the steps of:
receiving the plurality of raw ingredients from a plurality of sources;
storing the plurality of received raw ingredients, wherein the storing includes storing the plurality of received raw ingredients in a storage facility and wherein the storage facility includes a cold storage, a storage at a room temperature and a bulk storage, wherein the cold storage is used for storing an ingredient containing a raw meat, and wherein the storage at a room temperature is used for storing an ingredient having a storage life of 48 hours and wherein the bulk storage is used for storing an ingredient having a storage life of 1-2 weeks;
weighing a plurality of stored raw ingredients;
mixing a plurality of weighed raw ingredients;
grinding and milling a plurality of a mixed raw ingredients; and
conditioning the grinded and the milled plurality of raw ingredients.

11. The method according to claim 11, wherein the step of extruding the conditioned plurality of raw ingredients to form the bar further comprising the steps of:
mixing an appropriate amount of water with the plurality of conditioned raw ingredients to form a mixture;
molding the mixture to obtain a meal replacement bar, wherein the molding is done by an application of a die;
drying the meal replacement bar, and wherein the meal replacement bar is dried to a have a humidity content, and wherein the humidity content is 90%;
cooling a dried meal replacement bar, wherein the dried meal replacement bar is cooled by passing an air with an ambient temperature, wherein the ambient temperature is 15° C.-20° C.; and
enrobing a cooled meal replacement bar.
